(19) United States
(12) Patent Application Publication
(10) Pub. No.: US 2025/0197290 A1
(43) Pub. Date: Jun. 19, 2025

(54) PROCESS FOR MAKING TILES

(71) Applicant: Lamberti SPA, Albizzate (IT)

(72) Inventors: Andrea MASCARO, Gallarate (IT); Davide RICCO', Formigine (IT); Marco BIETTI, Formigine (IT); Simone ESPOSITO, Gallarate (IT)

(73) Assignee: Lamberti SPA, Albizzate (IT)

(21) Appl. No.: 18/877,335

(22) PCT Filed: Jun. 30, 2023
(86) PCT No.: PCT/EP2023/067977

§ 371 Date: Dec. 20, 2024

(30) Foreign Application Priority Data
Jul. 1, 2022 (IT) 102022000013963

(51) Int. Cl. C04B 33/13; B28B 1/26; C04B 33/04; C04B 33/16; C04B 33/20; C04B 35/626

(52) U.S. Cl. CPC C04B 33/1305; C04B 33/04; C04B 33/1315; C04B 33/16; C04B 33/20; C04B 35/6261; C04B 35/62655; B28B 1/26; C04B 2235/3418; C04B 2235/3427; C04B 2235/349; C04B 2235/604; C04B 2235/606

(57) ABSTRACT

A process for making tiles comprising: i) mixing the ceramic raw materials; ii) dry-grinding the ceramic raw materials or wet-grinding the ceramic raw materials and spray drying the ceramic slip obtained from the wet-grinding; iii) forming green tiles by pressing the powdery grinded ceramic raw materials obtained from step ii); said process being characterized by the addition to the ceramic raw materials, before step iii), of from 0.01 to 5.0% by weight, based on the weight of the ceramic raw materials (dry matter), of a composition comprising a polymer obtained by polymerization in the presence of a sugar or a degraded polysaccharide.

### TECHNICAL FIELD

The present invention relates to a process for making ceramic tiles characterized by the addition to conventional ceramic raw materials of a composition comprising a polymer obtained by polymerization in the presence of a sugar or a degraded polysaccharide.

### BACKGROUND OF THE ART

The process of making ceramic tiles generally involves the following steps:
i) mixing of the ceramic raw materials;
ii) dry-grinding the ceramic raw materials or wet-grinding the ceramic raw materials and spray-drying of the slips obtained from the wet-grinding;
iii) forming green tiles by pressing the powdery grinded raw materials obtained from step ii);
iv) drying the green tiles;
v) glazing the upper surface of the dried green tiles;
vi) firing the glazed green tiles.

The ceramic raw materials useful for the preparation of tiles are of two basic types: clayey materials (typically china clays and red vitrifiable clays); complementary inorganic materials (typically feldspars, feldspathoids, feldspathic sands, quartzes, pegmatites, etc.), having melting and/or inert features.

The purpose of grinding is to effect size reduction of the ceramic raw materials and to homogenise them until a final constant particle-size distribution has been achieved; generally speaking, after grinding, the residue on a 63 microns (230 mesh) sieve is around 0.5-10% by weight (wt %), depending on the nature of the ceramic materials.

Wet grinding provides wet grinded ceramic raw materials, also called ceramic slips, containing about 30-40 wt % of water.

Dry grinding is a less used technique, but is able to produce materials with a grain size distribution comparable with that obtained with a wet process. The subsequent step of forming requires dry raw materials (moisture content<10 wt %), so the ceramic slip obtained from the wet-grinding must be dried, usually by spray drying. The purpose of spray drying is to achieve a partial evaporation of the water contained in the slip (reduction of water content to 4-7 wt %) together with the formation of spheroid particles.

The typical particle size distribution of the powders after wet- or dry-grinding is 70-80 wt % of particles in the range from 425 to 180 microns. These powders are suitable, for example, in the production of vitrified single-fired tiles.

The purpose of forming the tile body by pressing is to obtain the utmost possible densification of the powders on green tiles; generally speaking, the specific forming pressure for the bodies is around 200-450 Kg/cm2.

Drying is the processing phase which eliminates the residual pressing moisture in the newly formed tiles; the tile bodies coming out of the presses are collected by roller lines and sent to the dryers, provided with inside channels dispensing hot air to the drying zone.

Glazing may be performed using the usual dry or wet application techniques.

Firing is performed in a kiln using pre-defined firing cycles; the firing cycles and temperatures generally fall respectively within the range of 20-60′ and 1100-1250° C., depending of the nature of the ceramic masses to be fired and on the size of the tiles themselves.

Forming and drying of the ceramic green tile bodies represent critical operations in the manufacture of the articles. Additives are commonly added in the preceding steps in order to reduce defects generated during pressing and drying. Typical additives are binders and plasticizers.

Binders are added for the specific purpose of cementing together the powdery raw materials and increasing the mechanical resistance of the dried and/or green tiles. They are often organic in nature (such as molasses, ligninsulfonates, starch and derivatives thereof); inorganic binders are also known and used (binder clays).

Plasticizers are added for the specific purpose of increasing the capacity of the slips to change permanently in size and shape during the forming of the tiles. Common organic plasticizers are derived from fossil raw materials: glycols, such as polyethylene glycols, polyvinyl alcohols, and polyacrylates. Also inorganic plasticizers are known. Examples of inorganic plasticizers are specific clays, such as the ball clays or clays belonging to the group of illite-chlorite and/or illite-kaolinite clays, but their use is limited by their relative high cost and periodical shortages.

In the recent years, there is a need to increase the amount of additives derived from renewable raw materials without incurring into black coring problems, which are typically associated to the use of large amount of organic additives.

CN104530318 describes a copolymer of acrylic acid and acrylamide or methylalkenyl polyoxyethylene ether (TPEG) grafted with corn starch and its use as ceramic reinforcing agent.

Surprisingly, it has now been found that a composition comprising a polymer obtained by polymerization in the presence of a sugar or a degraded polysaccharide, acts as a plasticizer and as a binder, when added to ceramic raw materials. In addition, said polymer does not cause the problems of black coring, has a predictable behavior and, since it has a little effect on the viscosity of ceramic raw material mixtures or of the ceramic slips, does not require any preliminary laboratory test and increases the strength of the green and/or the dried tile bodies.

### SUMMARY OF THE INVENTION

It is therefore an object of the present invention a process for making tiles comprising:
i) mixing the ceramic raw materials;
ii) dry-grinding the ceramic raw materials or wet-grinding the ceramic raw materials and spray drying the ceramic slip obtained from the wet-grinding;
iii) forming green tiles by pressing the powdery grinded ceramic raw materials obtained from step ii);
said process being characterized by the addition to the ceramic raw materials, before step iii), of from 0.01 to 5.0% by weight, based on the weight of the ceramic raw materials (dry matter), of a composition comprising, on dry weight basis, from 3 to 70% by weight of a polymer obtained by polymerization of:
   a) from 0 to 50% by weight of at least one ethylenically unsaturated monomer selected among styrene or substituted styrene,
   b) from 10 to 80% by weight of at least one ethylenically unsaturated monomer selected among C₁-C₁₀-alkyl (meth)acrylates or cycloalkyl (meth)acrylates,
   c) from 0 to 30% by weight of at least one ethylenically unsaturated monomer different from a) and b), in the presence of
   d) from 20 to 90% by weight of a sugar or a degraded polysaccharide having a molecular weight Mn of 500 to 30,000 Da,
wherein the percentage amounts of a), b), c) and d) are referred to the sum of a)+b)+c)+d).

### DETAILED DESCRIPTION OF THE INVENTION

Preferably, the process for making tiles of the invention comprises:
i) mixing the ceramic raw materials;
ii) dry-grinding the ceramic raw materials or wet-grinding the ceramic raw materials and spray drying the ceramic slip obtained from the wet-grinding;
iii) forming green tiles by pressing the powdery grinded ceramic raw materials obtained from step ii);
said process being characterized by the addition to the ceramic raw materials, before step iii), of from 0.1 to 3.0% by weight, based on the weight of the ceramic raw materials (dry matter), of a composition comprising, on dry weight basis, from 10 to 50% by weight of a polymer obtained by polymerization of:
   a) from 0 to 45% by weight of at least one ethylenically unsaturated monomer selected among styrene or substituted styrene,
   b) from 15 to 75% by weight of at least one ethylenically unsaturated monomer selected among C₁-C₁₀-alkyl (meth)acrylates or cycloalkyl (meth)acrylates,
   c) from 0 to 20% by weight of at least one ethylenically unsaturated monomer different from a) and b), in the presence of
   d) from 25 to 80% by weight of a sugar or a degraded polysaccharide having a molecular weight Mn of 500 to 20,000 Da,
wherein the percentage amounts of a), b), c) and d) are referred to the sum of a)+b)+c)+d).

According to the invention, the ethylenically unsaturated monomer a) is selected among styrene or substituted styrene. Suitable examples of substituted styrene are α-methylstyrene, ortho-, meta- or para-methylstyrene, ortho-, meta- or para-ethylstyrene, o,p-dimethylstyrene, o,p-diethylstyrene, isopropylstyrene, o-methyl-p-isopropylstyrene, α-butylstyrene, 4-n-butylstyrene or 4-n-decylstyrene. Preferably a) is styrene.

According to the invention, the ethylenically unsaturated monomer b) is selected among C₁-C₁₀ alkyl (meth)acrylates or cycloalkyl (meth)acrylates.

Suitable C₁-C₁₀ alkyl (meth)acrylates include methyl methacrylate, methyl acrylate, ethyl acrylate, ethyl methacrylate, propyl acrylate, propyl methacrylate, n-butyl acrylate, n-butyl methacrylate, iso-butyl acrylate, iso-butyl methacrylate tert-butyl acrylate, tert-butyl methacrylate, 2-ethylhexyl methacrylate, 2-ethylhexyl acrylate or mixtures thereof. Suitable cycloalkyl (meth)acrylates may include, for example, cyclohexyl (meth)acrylate, methyl cyclohexyl (meth)acrylate, dihydrodicyclopentadienyl (meth)acrylate, trimethylcyclohexyl (meth)acrylate, t-butyl cyclohexyl (meth)acrylate or mixtures thereof.

Preferred cycloalkyl (meth)acrylates are cyclohexyl methacrylate or cyclohexyl acrylate. Preferably b) is at least one selected among ethyl acrylate, butyl acrylate or cyclohexyl methacrylate.

According to the invention, the ethylenically unsaturated monomer c) is preferably at least one selected among acrylic acid or a salt thereof, methacrylic acid or a salt thereof, itaconic acid or a salt thereof, hydroxyethyl acrylate, hydroxyethyl methacrylate, hydroxypropyl acrylate, hydroxypropyl methacrylate, 2-acrylamido-2-methylpropane sulfonic acid or a salt thereof, or acrylamide.

According to the invention, d) is a sugar or a degraded polysaccharide.

Suitable sugars can be monosaccharides, disaccharides or sugar polyols. Suitable monosaccharides include glucose, galactose, fructose and xylose. Suitable disaccharides include sucrose, lactose, maltose, isomaltulose and trehalose. Suitable polyols include sorbitol and mannitol.

Suitable degraded polysaccharides have a molecular weight Mn of 500 to 30,000 Da, preferably from 500 to 20,000 Da, and are derived from polysaccharides such as starch, cellulose, cellulose ethers (such as carboxymethylcellulose), polygalactomannans or polygalactomannan ethers by partial depolymerization.

The average molecular weight of the degraded polysaccharides can be determined for example by using gel permeation chromatography, after calibration with pullulan standards.

According to a preferred embodiment, the degraded polysaccharide is a degraded starch having a molecular weight Mn of 500 to 30,000 Da, preferably from 500 to 20,000 Da. Said degraded starch is obtained from the degradation of natural starch or chemically modified starch. Suitable natural starches include potato, wheat, maize, rice or tapioca starch. Also suitable are chemically modified starches, such as for example hydroxyethyl starch, hydroxypropyl starch, acetylated starch or phosphate starch.

Degradation of the starches can be achieved enzymatically, oxidatively or hydrolytically through action of acids or bases. Degraded starches are commercially available. Said degraded starches can undergo further degradation, for example by treatment with hydrogen peroxide, before or after the polymerization is started.

Suitable degraded starches are also maltodextrins. The wide range of maltodextrins commercially available are described in terms of their “Dextrose Equivalent” value (DE), which is a measure of the amount of their reducing sugars, relative to dextrose, expressed as a percentage on a dry basis. The DE of maltodextrins varies between 3 and 20 and gives an indication of their average degree of polymerization (DP).

Preferably, the ethylenically unsaturated monomers a), b) and c) are selected so that theoretical glass transition temperature (Tg) of the obtained polymer is more than −30° C. and less than 60° C. The theoretical glass transition temperature (Tg) can be calculated by using the Fox equation (see T. G. Fox, Bull. Am. Phys. Soc., 1, 123 (1956)):

$$\frac{1}{Tg} = \frac{{x}_{1}}{{Tg}_{1}} + \frac{{x}_{2}}{{Tg}_{2}} + … \frac{{x}_{n}}{{Tg}_{n}}$$

wherein x₁, x₂ and xₙ are the mass fractions of the different monomers 1, 2, n and Tg₁, Tg₂, Tgₙ represent the actual glass transition temperatures in Kelvin of the corresponding homopolymers. The actual Tg values of the homopolymers are known and listed, for example, in J. Brandrup, E. H. Immergut, Polymer Handbook, 4th ed., J. Wiley, New York, 2004.

The polymer of the invention can be prepared following any of the polymerization process known in the art. Examples of these processes are: solution polymerization, emulsion polymerization, inverse emulsion polymerization, suspension polymerization, precipitation polymerization, etc., in the presence of catalytic systems and chain-transfer agents, or by a radical mediated system. Preferably, the polymer of the invention is obtained using an emulsion polymerization process.

The polymerization is usually carried out at temperatures of from 30 to 110° C., preferably from 50 to 100° C.

Thermal or redox initiation processes may be used. Conventional free radical initiators may be used such as, for example, hydrogen peroxide, t-butyl hydroperoxide, t-amyl hydroperoxide, alkali or ammonium persulfates, and azo initiators such as 4,4′-azobis(4-cyanopentanoic acid), and 2,2′-azobisisobutyronitrile (“AIBN”), typically at a level of 0.01% to 3.0% by weight, based on the weight of total monomers. Redox systems using the same initiators coupled with a suitable reductant such as, for example, sodium sulfoxylate formaldehyde, sodium hydrosulfite, isoascorbic acid, hydroxylamine sulfate and sodium bisulfite may be used at similar levels, optionally in combination with metal ions such as, for example, iron and copper, optionally further including complexing agents for the metal.

Chain transfer agents such as mercaptans may be used to lower the molecular weight of the polymers. Techniques to reduce residual monomers such as, for example, subjecting the reaction mixture to steam stripping, hold times, and additional radical sources may be employed.

The composition of the invention can further comprise, on dry weight basis, from 0 to 60% by weight, preferably from 10 to 50% by weight of at least one binder, said binder being selected among ligninsulfonates, naphthalene sulfonate-formaldehyde condensate salts, sulfonated melamine-formaldehyde condensates, swelling clays of the smectite family, acrylic (co) polymers, polyacrylamide, polyalkylene glycols, polyvinyl alcohol, lignin, sugars, starch, degraded starch, starch ethers, cellulose ethers or mixtures thereof.

Ligninsulfonates are a by-product of the production of wood pulp. As the organic lignin molecule combines with strongly polar sulfonic acid groups during sulfite pulping, ligninsulfonates are readily soluble in water in the form of their sodium, calcium or ammonia salts. Ligninsulfonates are available as yellowish powders having variable compositions and also variable molecular dimensions. A typical weight average molecular weight of the ligninsulfonates is about 30,000 dalton (Da) and its typical number average molecular weight is about 3,000 dalton.

Naphthalene sulfonate-formaldehyde condensate salts, also called NSF, have been known for some time and have been fully described also as dispersing agents in different sectors. In general, these materials are made by condensing molten naphthalene with fuming sulfuric acid to form naphthalene sulfonic acid derivatives having varying position isomers. The sulfonic acid derivative is then condensed with water and formaldehyde at temperatures of about 90° C. and thereafter converted to a salt by the addition of alkali metal or ammonium hydroxides or carbonates. The weight-average molecular weight of the naphthalene sulfonate formaldehyde condensate salts, suitable for the realization of the present invention, is preferably around 10,000 Da.

Swelling clays of the smectite family belong to a well known family of three-layer clay minerals containing a central layer of alumina or magnesia octahedra sandwiched between two layers of silica tetrahedra and have an idealized formula based on that of pyrophillite which has been modified by the replacement of some of the Al⁺³, Si⁺⁴, or Mg⁺² by cations of lower valency to give an overall anionic lattice charge. The swelling clays of the smectite family include montmorillonite, which includes bentonite, beidellite, nontronite, saponite and hectorite. The swelling clays usually have a cation exchange capacity of from 80 to 150 meq/100 g dry mineral and can be dispersed in water relatively easily.

Suitable sugars can be monosaccharides, disaccharides or sugar polyols. Suitable monosaccharides include glucose, galactose, fructose and xylose. Suitable disaccharides include sucrose, lactose, maltose, isomaltulose and trehalose. Suitable sugar polyols include sorbitol and mannitol.

Suitable degraded starches include dextrins and maltodextrins.

Suitable starch ethers include carboxymethyl starch, hydroxyethyl starch and hydroxypropyl starch.

Suitable cellulose ethers include low-viscosity carboxymethyl cellulose and hydroxyethyl cellulose. The carboxymethyl cellulose suitable for the realization of the present invention has a Brookfield® LVT viscosity, at 2% wt in water, 60 rpm and 20° C., is from 5 to 100 mPa*s, preferably from 5 to 50 mPa*s. The carboxymethyl cellulose preferred for the realization of the present invention has degree of substitution comprised between 0.5 and 1.5, more preferably between 0.6 and 1.2.

In the process of the invention, before step iii), other ceramic additives can be added, such as dispersants, preservatives, biocides, antifoams, de-airing agents, deflocculants, levelling agents and mixtures thereof.

In the process of the invention from 0.1 to 5% by weight, preferably from 0.7 to 3% by weight, based on the weight of the ceramic raw materials (dry matter), of a dispersant can be added, which can be chosen among those commonly used in the field. Examples of dispersants are (meth)acrylic acid polymers, usually provided as sodium salt; phosphonates, phosphates and polyphosphates, such as sodium tripolyphosphate; sodium metasilicate; sodium di-silicate; and mixtures thereof. Particularly preferred dispersants are (meth)acrylic acid polymers with a weight average molecular weight below 20,000 Da, and preferably below 10,000 Da, for instance from 1,000 to 6,000 Da.

Suitable biocides and preservatives are, for example, p-chloro-m-cresol, o-phenyl phenol, 2-bromo-2-nitropropane-1,3-diol (Bronopol) or compounds from the class of the derivatized isothiazolin-3-ones such as benzoisothiazolinone (BIT), 5-chloro-2-methyl-4-isothiazolin-3-one (CIT or CMIT) and 2-methyl-4-isothiazolin-3-one (MIT). Other examples are sodium or zinc pyrithione, parabens, sodium benzoate, formaldehyde releasers etc.

Examples of antifoams and de-airing agents suitable for the realization of the present invention are aluminum stearate, ethylene/propylene oxide copolymers, polydimethyl siloxanes, colloidal silica, mineral oils and mixture thereof.

Other common ceramic additives can be also added in the process of the invention. Example of such additives are perfumes, dyes and the like.

According to one embodiment, the composition of the invention is added in step i).

According to this embodiment, the combination of the ceramic raw materials and the composition of the invention is typically accomplished by mixing carefully the ceramic raw materials with the composition of the invention to form a homogeneous mixture.

This mixture is then subjected to grinding, which can be performed using either a wet- or dry-process (step ii)).

In another embodiment, the composition is added to the ceramic slips between grinding step and spray-drying.

The process of the invention also comprises the step of forming green tiles (step iii)), wherein the powdery intermediates are dry pressed in a forming die at operating pressures as high as 2,500 tons.

Usually, the process for making ceramic tiles further comprises the following steps: drying the green tiles, glazing the upper surface of the dried green tiles and finally firing the glazed tile bodies. These subsequent steps for the preparation of ceramic tiles can be accomplished by conventional techniques and procedures.

The process of the invention is suitable for the production of any kind of ceramic tile, such as wall tiles, floor tiles, stoneware, porcelain stoneware, rustic stoneware, earthenware tiles, mosaic tiles, which can be both single and double fired.

The following non-limiting examples illustrate the preparation of exemplary polymers and process using said polymers in accordance with the present invention.

### EXAMPLES

### Comparative Example 1

Fully acrylic copolymer, commonly used in the preparation of ceramic tiles.

### Example 2

133.6 g of maltodextrin (Maldex® 120, commercially available from Tereos) were dispersed with stirring in 433.4 g of demineralized water in a 1 L glass reactor with a cooling/heating jacket under a nitrogen atmosphere. The dextrin was dissolved by heating the mixture to 85° C.; after dextrin dissolution was completed, 0.04 g of aqueous solution of ferrous (II) sulfate heptahydrate dissolved in small amount of water were added into the reactor. After 15 minutes 5.42 g of 35% strength hydrogen peroxide were added. After 60 minutes, the dextrin degradation was complete. Then the monomers emulsion and initiator feeds were started. 144.4 g of water, 1.1 g of sodium lauryl sulfate, 3.61 g of acrylic acid, 66.8 g of n-butyl acrylate, 220.3 g of styrene and 84.9 of hydroxyethyl methacrylate were fed during 120 minutes. 41.5 g of 12% solution of hydrogen peroxide were fed simultaneously with the monomer feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 42.7% is obtained.

The theoretical glass transition temperature (Tg) of the polymer, calculated based on the ethylenically unsaturated monomers used, is 51° C.

### Example 3

135.2 g of maltodextrin (Maldex® 120, commercially available from Tereos) were dispersed with stirring in 438.6 g of demineralized water in a 1 L glass reactor with a cooling/heating jacket under a nitrogen atmosphere. The dextrin was dissolved by heating the mixture to 85° C.; after dextrin dissolution was completed, 0.04 g of aqueous solution of ferrous (II) sulfate heptahydrate dissolved in small amount of water were added into the reactor. After 15 minutes 5.48 g of 35% strength hydrogen peroxide were added. After 60 minutes, the dextrin degradation was complete. Then the monomers emulsion and initiator feeds were started. 146.2 g of water, 1.1 g of sodium lauryl sulfate, 3.66 g of acrylic acid, 155.3 g of n-butyl acrylate, 120.6 g of styrene and 85.9 of hydroxyethyl methacrylate were fed during 120 minutes. 23 g of 12% solution of hydrogen peroxide were fed simultaneously with the monomer feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 41.5% is obtained.

The theoretical glass transition temperature (Tg) of the polymer, calculated based on the ethylenically unsaturated monomers used, is 7° C.

### Example 4

145.3 g of a dextrin from potato starch (Avedex® 125 HI 12, commercially available from Avebe) were dispersed with stirring in 461.3 g of demineralized water in a 1 L glass reactor with a cooling/heating jacket under a nitrogen atmosphere. The dextrin was dissolved by heating the mixture to 85° C.; after dextrin dissolution was completed, 0.04 g of aqueous solution of ferrous (II) sulfate heptahydrate dissolved in small amount of water were added into the reactor. After 15 minutes 5.89 g of 35% strength hydrogen peroxide were added. After 60 minutes, the dextrin degradation was complete. Then the monomers emulsion and initiator feeds were started. 157.0 g of water, 1.1 g of sodium lauryl sulfate, 255.2 g of n-butyl acrylate and 137.4 g of styrene were fed during 120 minutes. 23 g of 12% solution of hydrogen peroxide were fed simultaneously with the monomer feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 42.7% is obtained.

The theoretical glass transition temperature (Tg) of the polymer, calculated based on the ethylenically unsaturated monomers used, is −17° C.

### Example 5

258.8 g of a dextrin from potato starch (Avedex® 125 HI 12, commercially available from Avebe) were dispersed with stirring in 476.4 g of demineralized water in a 1 L glass reactor with a cooling/heating jacket under a nitrogen atmosphere. The dextrin was dissolved by heating the mixture to 85° C.; after dextrin dissolution was completed, 0.06 g of aqueous solution of ferrous (II) sulfate heptahydrate dissolved in small amount of water were added into the reactor. After 15 minutes 10.55 g of 35% strength hydrogen peroxide were added. After 60 minutes, the dextrin degradation was complete. Then the monomers emulsion and initiator feeds were started. 121.6 g of water, 0.78 g of sodium lauryl sulfate, 169.2 g of n-butyl acrylate and 90.6 g of styrene were fed during 120 minutes. 22.6 g of 16% solution of hydrogen peroxide were fed simultaneously with the monomer feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 40.2% is obtained.

The theoretical glass transition temperature (Tg) of the polymer, calculated based on the ethylenically unsaturated monomers used, is −17° C.

### Example 6

276.9 g of a dextrin from potato starch (Tackidex® C172Y, commercially available from Roquette) were dispersed with stirring in 540 g of demineralized water in a 1 L glass reactor with a cooling/heating jacket under a nitrogen atmosphere. The dextrin was dissolved by heating the mixture to 85° C.; after dextrin dissolution was completed, 0.07 g of aqueous solution of ferrous (II) sulfate heptahydrate dissolved in small amount of water were added into the reactor. After 15 minutes 11.3 g of 35% strength hydrogen peroxide were added. After 60 minutes, the dextrin degradation was complete. Then the monomers emulsion and initiator feeds were started. 110.8 g of water, 0.7 g of sodium lauryl sulfate, 276.9 g of ethyl acrylate were fed during 120 minutes. 31.8 g of 12% solution of hydrogen peroxide were fed simultaneously with the monomer feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 41.1% is obtained.

The theoretical glass transition temperature (Tg) of the polymer, calculated based on the ethylenically unsaturated monomers used, is −24° C.

### Example 7

133.9 g of depolymerised acetylated starch (Sobex® 222, commercially available from Südstarke) were dispersed with stirring in 416.1 g of demineralized water in a 1 L glass reactor with a cooling/heating jacket under a nitrogen atmosphere. The dextrin was dissolved by heating the mixture to 85° C.; after dextrin dissolution was completed, 0.16 g of aqueous solution of ferrous (II) sulfate heptahydrate dissolved in small amount of water were added into the reactor. After 15 minutes 32.6 g of 35% strength hydrogen peroxide were added. After 60 minutes, the dextrin degradation was complete. Then the monomers emulsion and initiator feeds were started. 144.7 g of water, 1.1 g of sodium lauryl sulfate, 235.2 g of n-butyl acrylate and 126.6 g of styrene were fed during 120 minutes. 42.6 g of 12% solution of hydrogen peroxide were fed simultaneously with the monomer feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 41% is obtained.

The theoretical glass transition temperature (Tg) of the polymer, calculated based on the ethylenically unsaturated monomers used, is −17° C.

### Example 8

112.5 g of a dextrin from potato starch (Tackidex® C172Y, commercially available from Roquette) were dispersed with stirring in 364.9 g of demineralized water in a 1 L glass reactor with a cooling/heating jacket under a nitrogen atmosphere. The dextrin was dissolved by heating the mixture to 85° C.; after dextrin dissolution was completed, 0.03 g of aqueous solution of ferrous (II) sulfate heptahydrate dissolved in small amount of water were added into the reactor. After 15 minutes 4.56 g of 35% strength hydrogen peroxide were added. After 60 minutes, the dextrin degradation was complete. Then the monomers emulsion and initiator feeds were started. 121.6 g of water, 0.8 g of sodium lauryl sulfate, 197.6 g of ethyl acrylate and 106.4 g of cyclohexyl methacrylate were fed during 120 minutes. 35 g of 12% solution of hydrogen peroxide were fed simultaneously with the monomer feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 41.7% is obtained.

The theoretical glass transition temperature (Tg) of the polymer, calculated based on the ethylenically unsaturated monomers used, is 8° C.

### Example 9

339.5 g of a dextrin from potato starch (Avedex® 125 HI 12, commercially available from Avebe) were dispersed with stirring in 465.6 g of demineralized water in a 1 L glass reactor with a cooling/heating jacket under a nitrogen atmosphere. The dextrin was dissolved by heating the mixture to 85° C.; after dextrin dissolution was completed, 0.09 g of aqueous solution of ferrous (II) sulfate heptahydrate dissolved in small amount of water were added into the reactor. After 15 minutes 14.6 g of 35% strength hydrogen peroxide were added. After 60 minutes, the dextrin degradation was complete. Then the monomers emulsion and initiator feeds were started. 48.3 g of water, 0.3 g of sodium lauryl sulfate, 66.8 g of n-butyl acrylate and 36 g of styrene were fed during 120 minutes. 18 g of 8% solution of hydrogen peroxide were fed simultaneously with the monomer feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 41% is obtained.

The theoretical glass transition temperature (Tg) of the polymer, calculated based on the ethylenically unsaturated monomers used, is −16° C.

### Example 10

272 g of dextrose mono-hydrate were dispersed with stirring in 479 g of demineralized water in a 1 L glass reactor with a cooling/heating jacket under a nitrogen atmosphere. The dextrin was dissolved by heating the mixture to 85° C.; after dextrin dissolution was completed, 0.06 g of aqueous solution of ferrous (II) sulfate heptahydrate dissolved in small amount of water were added into the reactor. After 15 minutes 11.1 g of 35% strength hydrogen peroxide were added. After 60 minutes the monomers emulsion and initiator feeds were started.

113.6 g of water, 4.8 g of sodium lauryl sulfate, 157.2 g of n-butyl acrylate and 84.7 g of styrene were fed during 120 minutes. 23 g of 12% solution of hydrogen peroxide were fed simultaneously with the monomer feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 43.8% is obtained.

The theoretical glass transition temperature (Tg) of the polymer, calculated based on the ethylenically unsaturated monomers used, is −16° C.

### Example 11

212.8 g of a dextrin from potato starch (Tackidex® C₁₇₂Y, commercially available from Roquette) were dispersed with stirring in 399 g of demineralized water in a 1 L glass reactor with a cooling/heating jacket under a nitrogen atmosphere. The dextrin was dissolved by heating the mixture to 85° C.; after dextrin dissolution was completed, 0.05 g of aqueous solution of ferrous (II) sulfate heptahydrate dissolved in small amount of water were added into the reactor. After 15 minutes 8.7 g of 35% strength hydrogen peroxide were added. After 60 minutes, the dextrin degradation was complete. Then the monomers emulsions and initiator feeds were started. A first monomer emulsion (68.7 g of water, 0.3 g of sodium lauryl sulfate and 138 g of n-butyl acrylate) was fed during 60 minutes. Then a second monomer emulsion (31 g of water, 0.4 g of sodium lauryl sulfate and 74.5 g of styrene) was fed during 60 minutes. 18 g of 17% solution of hydrogen peroxide was fed simultaneously with the monomers feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 41.8% is obtained.

The theoretical glass transition temperature (Tg) of the polymer, calculated based on the ethylenically unsaturated monomers used, is −17° C.

### Example 12

212.8 g of a dextrin from potato starch (Tackidex® C₁₇₂Y, commercially available from Roquette) were dispersed with stirring in 399 g of demineralized water in a 1 L glass reactor with a cooling/heating jacket under a nitrogen atmosphere. The dextrin was dissolved by heating the mixture to 85° C.; after dextrin dissolution was completed, 0.05 g of aqueous solution of ferrous (II) sulfate heptahydrate dissolved in small amount of water were added into the reactor. After 15 minutes 8.7 g of 35% strength hydrogen peroxide were added. After 60 minutes, the dextrin degradation was complete. Then the monomers emulsions and initiator feeds were started. A first monomer emulsion (31 g of water, 0.4 g of sodium lauryl sulfate and 74.4 g of styrene) was fed during 60 minutes. Then a second monomer emulsion (69 g of water, 0.3 g of sodium lauryl sulfate and 138 g of n-butyl acrylate) was fed during 60 minutes. 18 g of 17% solution of hydrogen peroxide was fed simultaneously with the monomers feed during 120 min. The reactor temperature was kept at 85° C. during the feeds and 60 minutes after for post-polymerization. Then the mixture was cooled to 40° C. followed by pH adjustment to 8 with diluted ammonium hydroxide solution and cooling to room temperature. Filtration was performed using a 50 μm filter cloth. A finely divided dispersion with a solid content of 43.6% is obtained.

The theoretical glass transition temperature (Tg) of the polymer, calculated based on the ethylenically unsaturated monomers used, is −17° C.

The percentages by weight (wt %) of each component used in the preparation of the inventive polymers of Examples 2-12 and their Fox Tg are reported in Table 1 and Table 2. The amounts reported for the sugar or the degraded polysaccharides are based on their active content.

TABLE 1

| | 2 | 3 | 4 | 5 | 6 |
|---|---|---|---|---|---|
| Dextrose | | | | | |
| Avedex ® 125 HI 12 | | | 25 | 48 | 47 |
| Tackidex ® C172Y | | | | | |
| Maldex ® 120 | 25 | 25 | | | |
| Sobex ® 222 | | | | | |
| Butyl acrylate | 13 | 32 | 49 | 34 | |
| Styrene | 44 | 25 | 26 | 18 | |
| Ethyl acrylate | | | | | 53 |
| Acrylic acid | 1 | 1 | | | |
| Cyclohexyl methacrylate | | | | | |
| Hydroxyethyl methacrylate | 17 | 17 | | | |
| Fox Tg (° C.) | 51 | 7 | −17 | −17 | −24 |

TABLE 2

| | 7 | 8 | 9 | 10 | 11^{a} | 12^{b} |
|---|---|---|---|---|---|---|
| Dextrose | | | | 50.3 | | |
| Avedex ® 125 HI 12 | | | 75 | | | |
| Tackidex ® C172Y | | 25 | | | 48 | 48 |
| Maldex ® 120 | | | | | | |
| Sobex ® 222 | 25 | | | | | |
| Butyl acrylate | 49 | | 16 | 32.3 | 34 | 34 |
| Styrene | 26 | | 9 | 17.4 | 18 | 18 |
| Ethyl acrylate | | 49 | | | | |
| Acrylic acid | | | | | | |
| Cyclohexyl methacrylate | | 26 | | | | |
| Hydroxyethyl methacrylate | | | | | | |
| Fox Tg (° C.) | −17 | 8 | −16 | −17 | −17 | −17 |

^{a}core-shell polymer (core: butyl acrylate; shell: styrene)
^{b}core-shell polymer (core: styrene; shell: butyl acrylate)

### Applicative Tests

### Dissolution Test

The behavior of the polymers of the invention was evaluated by determining the viscosity by Ford viscosity cup (ASTM Standard Method D1200-10) on dispersions obtained by grinding 500 g of the ceramic raw materials of Table 3 with 240 g of tap water.

TABLE 3

| Ingredients | Parts |
|---|---|
| Refractory clay | 20 |
| Plastic clay | 10 |
| Feldspar | 30 |
| Sand | 39 |
| Reotan HS¹ | 1 |

¹polyacrylic dispersant, commercially available from Lamberti S.p.A.

Seven dispersion were prepared: one without any additive (blank), one with 0.4% by weight of the polymers of Comparative Example 1 and Examples 2-6.

The dispersions were homogenized by means of high speed mechanical stirrer equipped with a eight blades impeller, working at 320 rpm for 10 minutes. The results are reported in Table 4.

TABLE 4

| Examples | Ford viscosity (sec) |
|---|---|
| Blank* | 23 |
| 1* | 22.7 |
| 2 | 23.5 |
| 3 | 24.0 |
| 4 | 22.7 |
| 5 | 32.5 |
| 6 | 24 |

*Comparative

The results reported in Table 4 show that the addition of the polymers of the invention do not significantly increase the viscosity of the dispersions of ceramic raw materials, thus avoiding high viscosities and the problems that they would create, such as difficulties in grinding and in moving the slips through the various steps of the process.

### Strength Test

The performances of the polymers of the invention were determined on tiles bodies prepared with the slip previously described.

The polymers of Comparative Example 1 and Examples 2-6 were added to the ceramic slip in an amount equivalent to 0.4% by weight and carefully dispersed using a mechanical stirrer.

After homogenization, the slips were conditioned at 75-80° C. in oven for one night and grinded again to get particles with size below 0.75 mm.

At the end of the grinding process, the moisture content of the ceramic slips was adjusted to about 6% (with addition of water).

Green tile bodies (5 cm×10 cm, 0.5 cm thick) were prepared by means of a laboratory hydraulic press (Nannetti, Mod. Mignon SS/EA) applying a pressure of about 400 Kg/cm2 (Tiles 1-6).

A comparative green tile was prepared with the same procedure and with the sole ceramic raw materials.

The modulus of rupture (MOR) of the green tile bodies was determined according to the International Standard Test Method ISO 10545-4, using a laboratory fleximeter (Nannetti, Mod. FM96).

The MOR of the dry tile bodies was determined on the remaining tile bodies after drying in oven for 3 hours at 130° C.

The modulus of rupture is an index of the strength of the tile bodies. The results, expressed as % increase (mean values) of the strength of the tile bodies prepared using the polymers of Comparative Example 1 and Examples 2-6 (Tiles 1-6) compared to the strength of the comparative tile body (no additive added), are reported in Table 5.

TABLE 5

| Tile | % Green Strength | % Dry Strength |
|---|---|---|
| 1* | +11.1 | +82.4 |
| 2 | +6.9 | +95.9 |
| 3 | +11.1 | +79.6 |
| 4 | +13.9 | +93.2 |
| 5 | +9.7 | +90.5 |
| 6 | +2.8 | +111.3 |

*Comparative

The results reported in Table 5 show that the inventive polymers (Examples 2-6) can be used as additives in the process of making tiles and have similar or improved performances respect to a known synthetic acrylic polymer (Comparative Example 1).

1. A process for making tiles comprising:
i) mixing the ceramic raw materials;
ii) dry-grinding the ceramic raw materials or wet-grinding the ceramic raw materials and spray drying the ceramic slip obtained from the wet-grinding;
iii) forming green tiles by pressing the powdery grinded ceramic raw materials obtained from step ii);
said process being characterized by the addition to the ceramic raw materials, before step iii), of from 0.01 to 5.0% by weight, based on the weight of the ceramic raw materials (dry matter), of a composition comprising, on dry weight basis, from 3 to 70% by weight of a polymer obtained by polymerization of:
a) from 0 to 50% by weight of at least one ethylenically unsaturated monomer selected among styrene or substituted styrene,
b) from 10 to 80% by weight of at least one ethylenically unsaturated monomer selected among C1-C10-alkyl (meth)acrylates or cycloalkyl (meth)acrylates,
c) from 0 to 30% by weight of at least one ethylenically unsaturated monomer different from a) and b),
in the presence of
d) from 20 to 90% by weight of a sugar or a degraded polysaccharide having a molecular weight Mn of 500 to 30,000 Da,
wherein the percentage amounts of a), b), c) and d) are referred to the sum of a)+b)+c)+d).

2. The process for making tiles according to claim 1, wherein the composition further comprises from 0 to 60% by weight of at least one binder selected among ligninsulfonates, naphthalene sulfonate-formaldehyde condensate salts, sulfonated melamine-formaldehyde condensates, swelling clays of the smectite family, acrylic (co) polymers, polyacrylamide, polyalkylene glycols, polyvinyl alcohol, lignin, sugars, starch, degraded starch, starch ethers, cellulose ethers or mixtures thereof.

3. The process for making tiles according to claim 1, wherein the composition is added to the ceramic raw materials in an amount from 0.1 to 3.0% by weight, based on the weight of the ceramic raw materials (dry matter).

4. The process for making tiles according to claim 1, wherein the degraded polysaccharide having a molecular weight Mn of 500 to 30,000 Da is derived from starch, cellulose, cellulose ethers (such as carboxymethylcellulose), polygalactomannans or polygalactomannan ethers.

5. The process for making tiles according to claim 1, wherein the degraded polysaccharide has a molecular weight Mn of 500 to 20,000 Da.

6. The process for making tiles according to claim 1, wherein the sugar is glucose, galactose, fructose, xylose, sucrose, lactose, maltose, isomaltulose, trehalose, sorbitol or mannitol.

7. The process for making tiles according to claim 1, wherein a) is styrene.

8. The process for making tiles according to claim 1, wherein b) is at least one selected among ethyl acrylate, butyl acrylate or cyclohexyl methacrylate.

9. The process for making tiles according to claim 1, wherein c) is at least one selected among acrylic acid or a salt thereof, methacrylic acid or a salt thereof, itaconic acid or a salt thereof, hydroxyethyl acrylate, hydroxyethyl methacrylate, hydroxypropyl acrylate, hydroxypropyl methacrylate, 2-acrylamido-2-methylpropane sulfonic acid or a salt thereof, or acrylamide.

10. The process for making tiles according to claim 1, wherein the ethylenically unsaturated monomers a), b) and c) are selected so that theoretical glass transition temperature (Tg) of the obtained polymer is more than −30° C. and less than 60° C.
